(19) United States
(12) Patent Application Publication
(10) Pub. No.: US 2019/0053480 A1
(43) Pub. Date: Feb. 21, 2019

(54) Attachable Hoof Pick System

(71) Applicant: Joseph Henry Cavin, Aztec, NM (US)

(72) Inventor: Joseph Henry Cavin, Aztec, NM (US)

(21) Appl. No.: 16/106,790

(22) Filed: Aug. 21, 2018

Related U.S. Application Data
(60) Provisional application No. 62/548,000, filed on Aug. 21, 2017.

(51) Int. Cl. A01L 15/00; F16B 21/09

(52) U.S. Cl. CPC A01L 15/00; F16B 21/09

(57) ABSTRACT

An attachable hoof pick system includes a hoof pick, a saddle, and a fastening mechanism. The hoof pick that is used to clean the hoof of a hoofed animal such as a horse includes a pick section, a body section, and a plurality of attachment holes. The pick section is adjacently connected to the body section as the plurality of attachment holes is traverses through the body section. The fastening mechanism, preferably a twist stud system, is engaged with the plurality of attachment holes so that the body section can be removably mounted to an exterior surface of the saddle by the fastening mechanism. Resultantly, the hoof pick and the saddle are able to maintain a secured and unsecured configuration through the fastening mechanism.

The current application claims a priority to the U.S. Provisional Patent application Ser. No. 62/548,000 filed on Aug. 21, 2017.

### FIELD OF THE INVENTION

The present invention relates generally to a handheld hoof pick. More specifically, the present invention relates to a hoof pick that is easily and securely attached to a saddle through a fastening mechanism.

### BACKGROUND OF THE INVENTION

A hoof pick is a small tool that is used to clean the hoof of a hoofed animal such as a horse. Hoof picks typically remove mud, manure, dirt, ice or snow, and stones from the sole of the hooves for the horse. The hoof pick has a blunt point, referred to as the pick, to clean the hoof. The removal of mud and manure helps to prevent thrush, a common hoof ailment which in very severe cases may cause lameness. The removal of rocks helps to prevent stone bruises. In addition to the physical benefits of cleaning the hooves, the opportunity to carefully inspect all four hooves for injury, illness or excessive ware from walking or running on hard or abrasive surfaces can help the horse maintain healthy hooves. Hooves should typically be cleaned daily, both before and after riding the horse. If the horse is not ridden, it is still best practice to check and clean the hooves frequently.

The use of hoof picks is crucial for the maintenance of horses and is used often. Because hoof picks are used so often, convenient access to hoof picks is important. Many hoof picks come with a single hole for hanging the hoof pick on a hook. Many users loop a string through the hole in order to hang the hoof pick from a hook. These hoof picks need to be hung where there is a wall with a hook. There are no means for the hoof picks to be attached to the actual saddle. A user could secure the hoof pick onto the saddle with the use of straps but the hoof pick may not be secure and could easily come loose during a ride. Some users have a hoof pick holder or case that can be attached to a saddle. The hoof pick case can protect the hoof pick and securely hold the hoof pick on the saddle. However, doing so may add additional unwanted bulkiness and weight.

An objective of the present invention is to provide a method of attaching the hoof pick itself, onto any surface. Rather than hanging the hoof pick or carrying the hoof pick by a case, the present invention allows the user to attach the hoof pick onto any surface. The present invention is a hoof pick with a plurality of holes and a plurality of fasteners. The plurality of fasteners can be screwed or bolted onto any surface or preferably a saddle. The hoof pick can easily be securely attached to the surface. The user can also conveniently access and detach the hoof pick. The use of the plurality of fasteners and the holes in the hoof pick do not add or take away any substantial weight and does not add any additional bulkiness like that of a hoof pick holder. The user can simply utilize the plurality of fasteners to attach or detach the hoof pick. The plurality of fasteners is often used to attach tarps to boats, pick-up beds, and of the like. However, the particular use of the plurality of fasteners in combination with the hoof pick is a unique and novel improvement to hoof picks. The use of the plurality of fasteners provides a more secure means of attachment, relative to other attachable hoof picks such as the magnetic hoof pick. For example, when the horse is in a sprint, the hoof pick can easily come lose and fall off the saddle if secured by a magnet. The plurality of fasteners of the present invention ensures that the hoof pick remains securely attached to the saddle. Another objective of the present invention is to provide a way for the user to display the hoof pick. Some hoof picks are customized in the ornamental design of the handle. The present invention allows the hoof pick to be attached to a surface such as the saddle such that the hoof pick is visible thus displaying the ornamental design.

### BRIEF DESCRIPTION OF THE DRAWINGS

FIG. 1 is a perspective view of the present invention showing the saddle, the hoof pick, and the fastening mechanism.

FIG. 2 is a perspective exploded view of the present invention showing the saddle, the hoof pick, and the fastening mechanism.

FIG. 3 is a detail view of the saddle of the present invention showing the fastening mechanism, wherein the hoof pick is detached during the unsecured configuration.

FIG. 4 is a detail view of the saddle of the present invention showing the fastening mechanism, wherein the hoof pick is attached during the secured configuration.

FIG. 5 is a front view for the hoof pick of the present invention.

FIG. 6 is a front perspective view for the hoof pick of the present invention.

FIG. 7 is a rear perspective view for the hoof pick of the present invention.

### DETAIL DESCRIPTIONS OF THE INVENTION

All illustrations of the drawings are for the purpose of describing selected versions of the present invention and are not intended to limit the scope of the present invention.

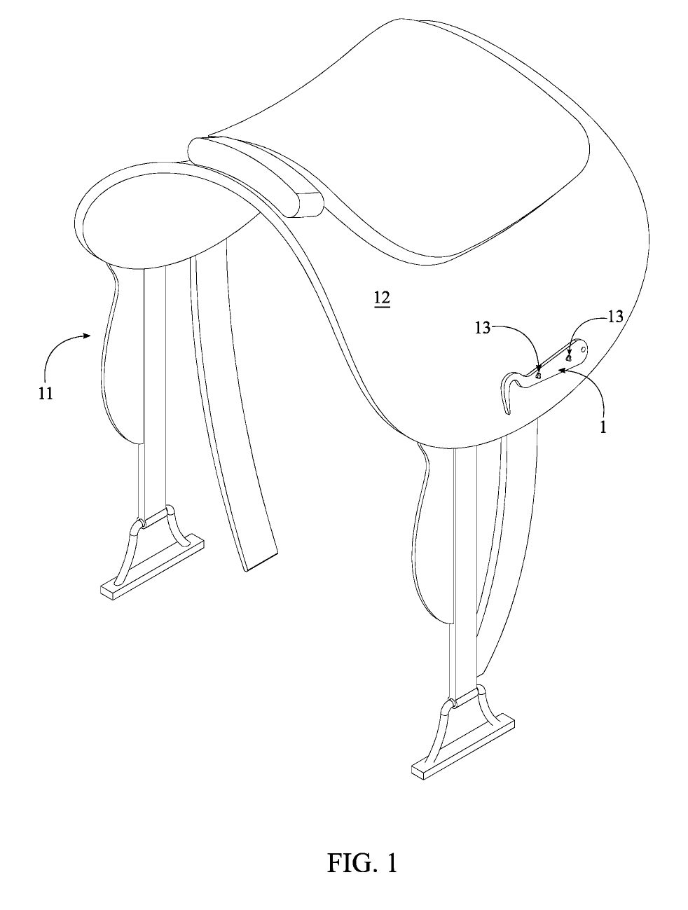

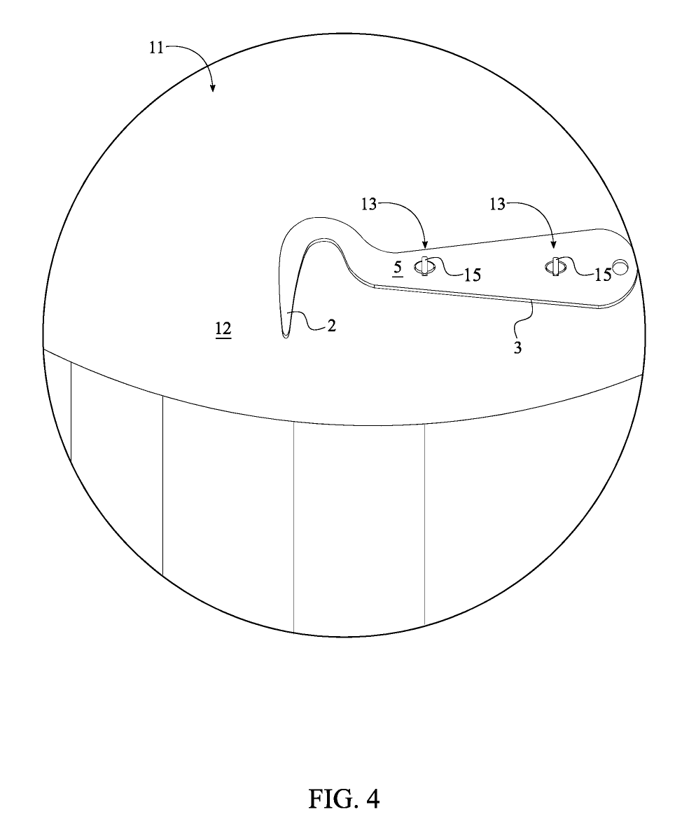

The present invention is an attachable hoof pick system that easily and securely attaches a hoof pick 1 to a horse saddle. As a result, users of the present invention, horse riders and caregivers, are able to conveniently access the hoof pick 1. The ability to fasten the hoof pick 1 in this manner allows the users to access the hoof pick 1 at all times, even during a ride when a user is far from the stall. The convenient ability to position and attach the hoof pick 1 onto any location provides a convenience that is useful to riders. For example, due to the convenient positioning of the hoof pick 1 within a horse saddle, the arena performance horse riders can easily access the hoof pick 1 when they need to clean the hooves for better footing right before going in the arena. In reference to FIG. 1 and FIG. 4, the present invention comprises the hoof pick 1, a saddle 11, and a fastening mechanism 13. The hoof pick 1 that typically removes mud, manure, dirt, ice or snow, and stones from the sole of the hooves for the horse comprises a pick section 2, a body section 3, a first surface 4, a second surface 5, and a plurality of attachment holes 6. The saddle 11 functions as a supportive structure for a rider and is fastened to the back of horse by a girth. In reference to the general configuration of the present invention, the body section 3 of the hoof pick 1 is removably mounted to an exterior surface 12 of the saddle 11 by the fastening mechanism 13 as the fastening mechanism 13 is engaged with the plurality of attachment holes 6.

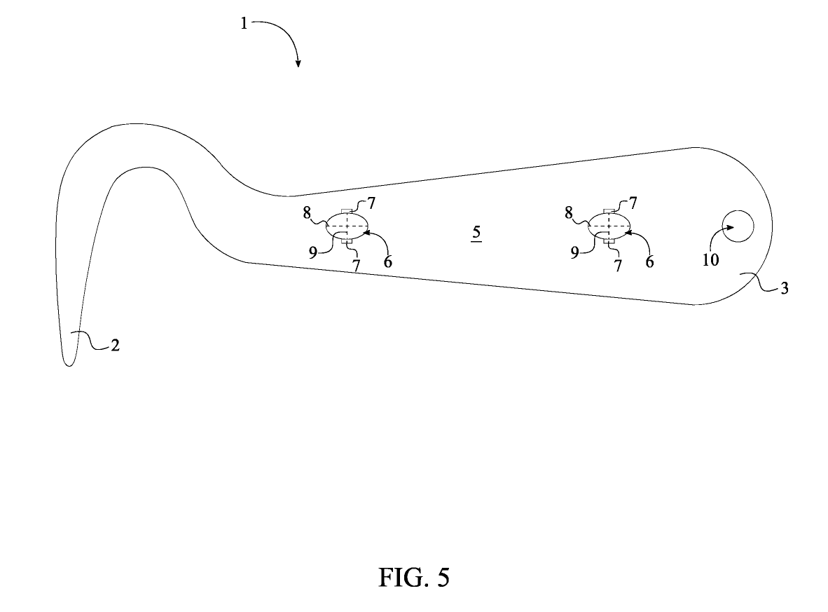

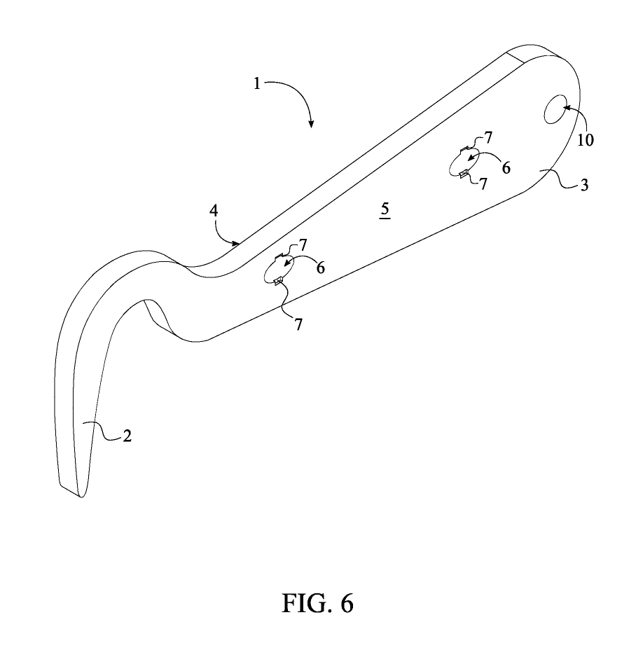

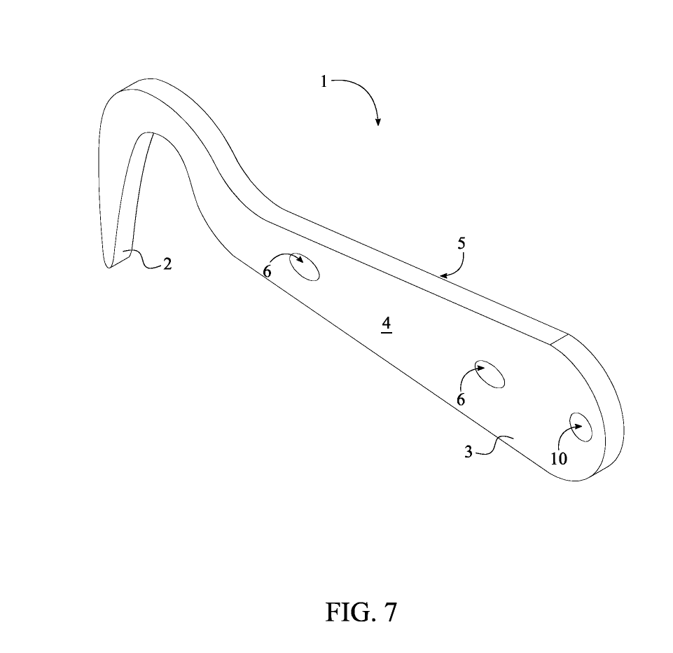

In reference to FIG. 5-7, the pick section 2 is adjacently connected to the body section 3 thus completing the profile of the hoof pick 1. Similar to existing hoof-picks, the pick section 2 is the blunt point that is used to clean the hoof by removing any mud, manure, ice, snow, and rocks. The body section 3 is the remaining portion of the hoof pick 1 which the user uses as a handle to maneuver the pick section 2. Resultantly, the body section 3 provides the necessary surface area to grasp the present invention while the pick section 2 is outwardly exposed from the user's hand. The first surface 4 and the second surface 5 are oppositely positioned of each other about the hoof pick 1 body, delineating the elongated front and rear surface for the hoof pick 1. In reference to FIGS. 6-7, the first surface 4 that is oppositely positioned of the second surface 5 is oriented towards the exterior surface 12 of the saddle 11 as the second surface 5 is oriented outwards towards the user.

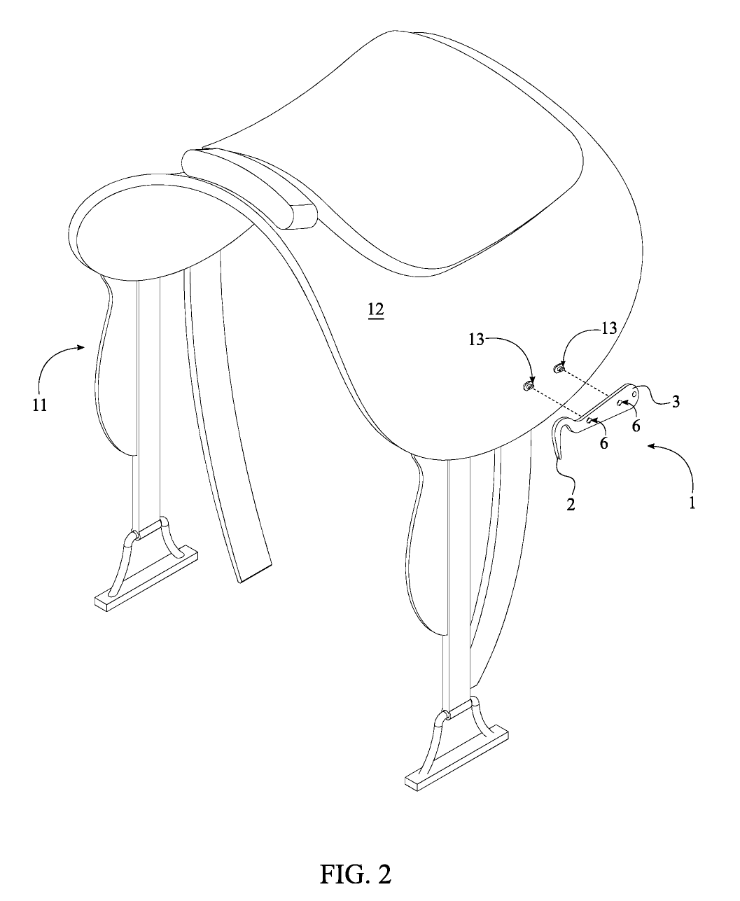

In reference to FIG. 5, the plurality of attachment holes 6 is positioned along the body section 3 of the hoof pick 1 and traverses through the body section 3. More specifically, the plurality of attachment holes 6 is an opening through the entire thickness of the hoof pick 1. Each of the plurality of attachment holes 6 is meant to receive the fastening mechanism 13. The shape and size of each of the plurality of attachment holes 6 is equal and sufficient to properly receive the fastening mechanism 13. The distance between each of the plurality of attachment holes 6 determine the distance between the numbers of fastening mechanisms 13, as seen in FIG. 2. In order to reduce the stress that is acting upon the fastening mechanism 13 due to the weight of the hoof pick 1, the plurality of attachment holes 6 is positioned in a way that the weight of the hoof pick 1 is evenly distributed. In the preferred embodiment of the present invention, the plurality of attachment holes 6 comprises a first hole and a second hole. The first hole is positioned adjacent to the pick section 2, at a first distance that is proximal to the pick section 2. The second hole is linearly positioned to the first hole, at a second distance that larger than the first distance. Even though the preferred embodiment of the present invention comprises the first hole and the second hole, the plurality of attachment holes 6 of the present invention is not limited to two holes and can be any number of holes as long as the weight of the hoof pick 1 is evenly distributed amongst them. When the hoof pick 1 further comprises a decorative plate that is connected to the body section 3, the plurality of attachment holes 6 traverses through the body section 3 and the decorative plate thus allowing fastening mechanism 13 to engaged with the hoof pick 1.

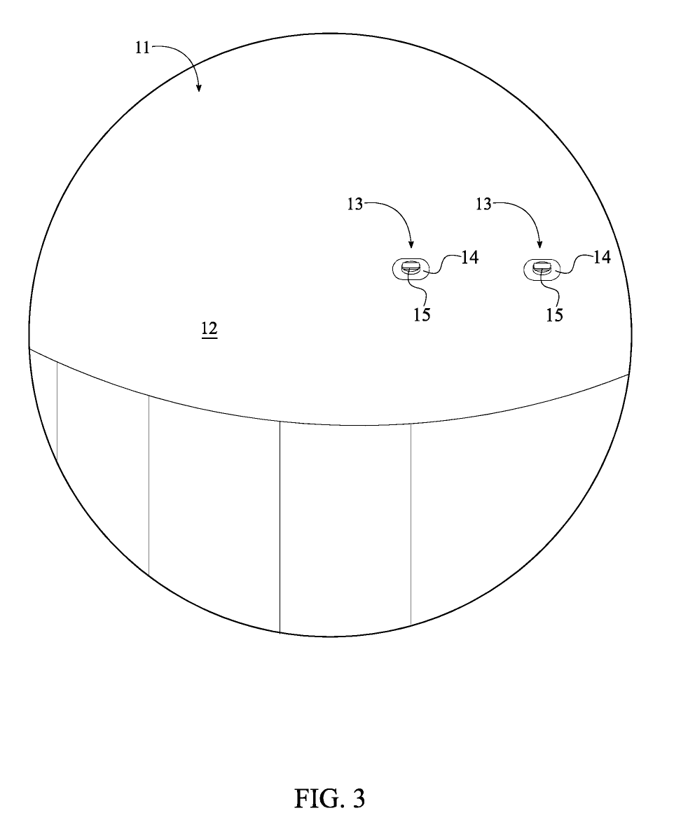

In reference to FIG. 3, the fastening mechanism 13 that secures the hoof pick 1 to the saddle 11 comprises a base 14 and a twist stud 15. More specifically, the base 14 is connected onto the exterior surface 12 of the saddle 11 thus securing the fastening mechanism 13 to the saddle 11. The preferred embodiment of the present invention, the base 14 is connected onto the exterior surface 12 of the saddle 11 by a pair of screw fasteners. However, the connection between the base 14 and the saddle 11 is not limited to the pair of screw fasteners and can be any other type of fasteners such as adhesive layers, magnetic fasteners, stitching, and rivets. The twist stud 15 functions as the locking member within the fastening mechanism 13 and provides the surface area to grasp the fastening mechanism 13 during operation. The twist stud 15 is tensionably and rotatably connected onto the base 14, opposite of the exterior surface 12 of the saddle 11. The twist stud 15 rotates in between a secured configuration and an unsecured configuration so that the twist stud 15 is able to selectively engage with the body section 3 through each of the plurality of attachment holes 6. During operation, the twist stud 15 is concentrically positioned to each of the plurality of attachment holes 6 so that the twist stud 15 can be extended beyond the second surface 5 of the hoof pick 1. The rotatable connection of the base 14 and the twist stud 15 allows the twist stud 15 to be rotated 360 degrees around the base 14 thus enabling the operation between the secured configuration and the unsecured configuration. The tension between the twist stud 15 and the base 14 allows the twist stud 15 to pull towards the second surface 5 during the secured configuration. As a result, the twist stud 15 can securely mount the hoof pick 1 to the saddle 11 while eliminating accidental dislodgment of the hoof pick 1.

In reference to FIG. 5-7, the hoof pick 1 may further comprises a lanyard opening 10 that traverses through the body section 3. More specifically, the lanyard opening 10 is positioned adjacent to the plurality of attachment holes 6, opposite of the pick section 2. The lanyard opening 10 can be utilized to hang the hoof pick 1 through a screw or a nail. Furthermore, the lanyard opening 10 enables a lanyard to be inserted through or connected with the hoof pick 1 thus providing an extended hanging feature.

In reference to FIG. 5, each of the plurality of attachment holes 6 comprises a pair of recesses 7, a long axis 8, and a short axis 9. The axis and the short axis 9 collectively delineate an oval shape for each of the plurality of attachment holes 6 as the long axis 8 and the short axis 9 are positioned perpendicular to each other within each of the plurality of attachment holes 6. More specifically, the long axis 8 is oriented along the body section 3 thus positioning the short axis 9 perpendicular to the body section 3. The pair of recesses 7 is perimetrically positioned around each of the plurality of attachment holes 6 and traverses into the body section 3 from the second surface 5 and diametrically opposed of each other along the short axis 9. As a result, the twist stud 15 can be fitted into the pair of recesses 7 during the secured configuration and positions away from the pair of recesses 7 during the unsecured configuration.

In reference to the secured configuration that is shown in FIG. 4, the twist stud 15 is engaged within the pair of recesses 7 of each of the plurality of attachment holes 6 and positioned parallel with the short axis 9 of each of the plurality of attachment holes 6. Additionally, the first surface 4 is positioned adjacent to the exterior surface 12 of the saddle 11. Due to the fact length of the twist stud 15 is greater than the length of the short axis 9, the twist stud 15 is able to glide over the second surface 5 and snap into the pair of recesses 7 thus securing the hoof pick 1 to the saddle 11.

In reference to the unsecured configuration that is shown in FIG. 2, the twist stud 15 is offset from the pair of recesses 7 of each of the plurality of attachment holes 6 and positioned parallel with the long axis 8 of each of the plurality of attachment holes 6. Additionally, the first surface 4 is positioned offset from the exterior surface 12 of the saddle 11. Due to the fact length of the twist stud 15 is shorter than the length of the long axis 8, the twist stud 15 is able to slide in and out of the plurality of attachment holes 6 thus enabling the hoof pick 1 to be detached from the saddle 11.

Although the invention has been explained in relation to its preferred embodiment, it is to be understood that many other possible modifications and variations can be made without departing from the spirit and scope of the invention as hereinafter claimed.

What is claimed is:

1. An attachable hoof pick system comprises:
a hoof pick;
a saddle;
a fastening mechanism;
the hoof pick comprises a pick section, a body section, and a plurality of attachment holes;
the pick section being adjacently connected to the body section;
the plurality of attachment holes traversing through the body section;
the fastening mechanism being engaged with the plurality of attachment holes; and
the body section being removably mounted to an exterior surface of the saddle by the fastening mechanism.

2. The attachable hoof pick system as claimed in claim 1 comprises:
the hoof pick further comprises a first surface and a second surface;
the first surface and the second surface being oppositely positioned of each other about the hoof pick; and
the first surface being oriented towards the exterior surface.

3. The attachable hoof pick as claimed in claim 1 comprises:
each of the plurality of attachment holes comprises a pair of recesses, a long axis, and a short axis, wherein each of the plurality of attachment holes is an oval shape;
the long axis and the short axis being positioned perpendicular to each other within each of the plurality of attachment holes;
the long axis being oriented along the body section;
the pair of recesses being perimetrically positioned around each of the plurality of attachment holes;
the pair of recesses being traversing into the body section from a second surface of the hoof pick; and
the pair of recesses being diametrically opposed of each other along the short axis.

4. The attachable hoof pick as claimed in claim 1 comprises:
the fastening mechanism comprises a base and a twist stud;
the base being connected onto the exterior surface of the saddle;
the twist stud being tensionably and rotatably connected onto the base, opposite of the exterior surface of the saddle;
the twist stud being concentrically positioned to each of the plurality of attachment holes; and
the twist stud being selectively engaged with the body section through each of the plurality of attachment holes.

5. The attachable hoof pick as claimed in claim 4 comprises:
a secured configuration;
the first surface being positioned adjacent to the exterior surface;
the twist stud being engaged within a pair of recesses of each of the plurality of attachment holes; and
the twist stud being positioned parallel with a short axis of each of the plurality of attachment holes.

6. The attachable hoof pick as claimed in claim 4 comprises:
an unsecured configuration;
the first surface being positioned offset from the exterior surface;
the twist stud being offset from each of the plurality of attachment holes; and
the twist stud being positioned parallel with a long axis of each of the plurality of attachment holes.

7. An attachable hoof pick system comprises:
a hoof pick;
a saddle;
a fastening mechanism;
the hoof pick comprises a pick section, a body section, and a plurality of attachment holes;
the fastening mechanism comprises a base and a twist stud;
the pick section being adjacently connected to the body section;
the plurality of attachment holes traversing through the body section;
the base being connected onto the exterior surface of the saddle;
the twist stud being tensionably and rotatably connected onto the base, opposite of the exterior surface of the saddle;
the twist stud being concentrically positioned to each of the plurality of attachment holes; and
the twist stud being selectively engaged with the body section through each of the plurality of attachment holes.

8. The attachable hoof pick system as claimed in claim 7 comprises:
the hoof pick further comprises a first surface and a second surface;
the first surface and the second surface being oppositely positioned of each other about the hoof pick; and
the first surface being oriented towards the exterior surface.

9. The attachable hoof pick as claimed in claim 7 comprises:
each of the plurality of attachment holes comprises a pair of recesses, a long axis, and a short axis, wherein each of the plurality of attachment holes is an oval shape;
the long axis and the short axis being positioned perpendicular to each other within each of the plurality of attachment holes;
the long axis being oriented along the body section;
the pair of recesses being perimetrically positioned around each of the plurality of attachment holes;
the pair of recesses being traversing into the body section from a second surface of the hoof pick; and
the pair of recesses being diametrically opposed of each other along the short axis.

10. The attachable hoof pick as claimed in claim 9 comprises:
a secured configuration;
the first surface being positioned adjacent to the exterior surface;
the twist stud being engaged within a pair of recesses of each of the plurality of attachment holes; and
the twist stud being positioned parallel with a short axis of each of the plurality of attachment holes.

11. The attachable hoof pick as claimed in claim 9 comprises:
an unsecured configuration;
the first surface being positioned offset from the exterior surface;
the twist stud being offset from each of the plurality of attachment holes; and
the twist stud being positioned parallel with a long axis of each of the plurality of attachment holes.

12. An attachable hoof pick system comprises:
a hoof pick;
a saddle;
a fastening mechanism;
the hoof pick comprises a pick section, a body section, and a plurality of attachment holes;
each of the plurality of attachment holes comprises a pair of recesses, a long axis, and a short axis, wherein each of the plurality of attachment holes is an oval shape;
the fastening mechanism comprises a base and a twist stud;
the pick section being adjacently connected to the body section;
the plurality of attachment holes traversing through the body section;
the long axis and the short axis being positioned perpendicular to each other within each of the plurality of attachment holes;
the long axis being oriented along the body section;
the pair of recesses being perimetrically positioned around each of the plurality of attachment holes;
the pair of recesses being traversing into the body section from a second surface of the hoof pick;
the pair of recesses being diametrically opposed of each other along the short axis;
the base being connected onto the exterior surface of the saddle;
the twist stud being tensionably and rotatably connected onto the base, opposite of the exterior surface of the saddle;
the twist stud being concentrically positioned to each of the plurality of attachment holes; and
the twist stud being selectively engaged with the body section through each of the plurality of attachment holes.

13. The attachable hoof pick system as claimed in claim 12 comprises:
the hoof pick further comprises a first surface;
the first surface and the second surface being oppositely positioned of each other about the hoof pick; and
the first surface being oriented towards the exterior surface.

14. The attachable hoof pick as claimed in claim 12 comprises:
each of the plurality of attachment holes comprises a pair of recesses, a long axis, and a short axis, wherein each of the plurality of attachment holes is an oval shape;
the long axis and the short axis being positioned perpendicular to each other within each of the plurality of attachment holes;
the long axis being oriented along the body section;
the pair of recesses being perimetrically positioned around each of the plurality of attachment holes;
the pair of recesses being traversing into the body section from the second surface; and
the pair of recesses being diametrically opposed of each other along the short axis.

15. The attachable hoof pick as claimed in claim 14 comprises:
a secured configuration;
the first surface being positioned adjacent to the exterior surface;
the twist stud being engaged within a pair of recesses of each of the plurality of attachment holes; and
the twist stud being positioned parallel with a short axis of each of the plurality of attachment holes.

16. The attachable hoof pick as claimed in claim 14 comprises:
an unsecured configuration;
the first surface being positioned offset from the exterior surface;
the twist stud being offset from each of the plurality of attachment holes; and
the twist stud being positioned parallel with a long axis of each of the plurality of attachment holes.
